(19) United States
(12) Patent Application Publication
(10) Pub. No.: US 2011/0234563 A1
(43) Pub. Date: Sep. 29, 2011

(54) Pixel circuits, display apparatuses including the pixel circuits, and methods of driving the display apparatuses

(75) Inventors: Jung-woo Kim, Hwaseong-si (KR); Young-tea Chun, Suwon-si (KR)

(73) Assignee: Samsung Electronics Co., Ltd.

(21) Appl. No.: 12/926,557

(22) Filed: Nov. 24, 2010

(30) Foreign Application Priority Data
Mar. 26, 2010 (KR) 10-2010-0027539

(51) Int. Cl. G09G 5/00

(52) U.S. Cl. 345/211

(57) ABSTRACT

Example embodiments are directed to a pixel circuit, a display apparatus including the pixel circuit, and a method of driving the display apparatus. The pixel circuit of the display apparatus uses a first transistor as a switching transistor to which a plurality of scan signals and a plurality of data signals are applied. The first transistor controls a second transistor to turn ON or OFF by storing the scan signals in a capacitor electrically connected to a second electrode of the first transistor. A first and second common power is applied to an opposite electrode of a display element and a second electrode of the second transistor, respectively, thereby separating an addressing operation and a displaying operation performed with respect to all of pixels.

### CROSS-REFERENCE TO RELATED APPLICATIONS

This application claims priority under 35 U.S.C. §119 to Korean Patent Application No. 10-2010-0027539, filed on Mar. 26, 2010, in the Korean Intellectual Property Office, the disclosure of which is incorporated herein in its entirety by reference.

### BACKGROUND

1. Field

Example embodiments relate to pixel circuits, display apparatuses including the pixel circuits, and methods of driving the display apparatuses.

2. Description of the Related Art

Display apparatuses, such as liquid crystal displays (LCDs), plasma display panels (PDPs), organic light emitting devices (OLEDs), and the like, are widely used. Such display apparatuses form images by using light sources, such as with LCDs, or by emitting light by themselves such as with PDPs and OLEDs. Therefore, relatively high power is consumed to drive display apparatuses like LCDs, PDPs, and OLEDs.

E-paper displays, such as electrochromic displays, have been proposed as new display devices. For example, electrochromic displays use an electrochromic effect of electrochromic elements. In the electrochromic effect, a molecular structure of an electrochromic material chemically or physically changes when stimulated by an external stimulus, such as electricity. When no voltage is applied to an electrochromic display, the electrochromic display can maintain an image currently displayed, and thus the electrochromic display can be used as an e-paper display. However, since electrochromic elements have a relatively slow response speed, electrochromic displays that use line-by-line addressing take a long time to display a whole image and a frame rate of the electrochromic displays is slow according to a high resolution.

### SUMMARY

According to example embodiments, a pixel circuit includes a display element including a pixel electrode and an opposite electrode to which a first common power is applied; a first transistor including a first electrode to which a data signal is applied, a second electrode electrically connected to a first node, and a gate to which a scan signal is including; a capacitor including a first electrode electrically connected to the first node and a second electrode; and a second transistor including a first electrode electrically connected to the pixel electrode, a second electrode to which a second common power is applied, and a gate electrically connected to the first node.

According to example embodiments, the second electrode of the capacitor is electrically connected to a line to which the second common power is applied or is grounded.

According to example embodiments, the first and second transistors are amorphous silicone thin film transistors or oxide thin film transistors.

According to example embodiments, the display element is an electrochromic element, a liquid crystal element, or an electronic ink element.

According to example embodiments, a display apparatus includes a plurality of scan lines to which a plurality of scan signals are applied; a plurality of data lines intersecting the plurality of scan lines and to which a plurality of data signals are applied; a first common power line to which a first common power is supplied; a second common power line to which a second common power is supplied; and a plurality of pixels at locations where the plurality of scan lines and the plurality of data lines intersect each other, wherein each of the plurality of pixels includes: a display element including a pixel electrode and an opposite electrode electrically connected to the first common power line; a first transistor including a first electrode electrically connected to one of the plurality of data lines and to which a data signal is applied, a second electrode electrically connected to a first node, and a gate electrically connected to one of the plurality of scan lines and to which a scan signal is applied; a capacitor including a first electrode electrically connected to the first node and a second electrode; and a second transistor including a first electrode electrically connected to the pixel electrode, a second electrode electrically connected to the second common power line, and a gate electrically connected to the first node.

According to example embodiments, wherein the second electrode of the capacitor is electrically connected to the second common power line or is grounded.

According to example embodiments, wherein the first and second transistors are amorphous silicone thin film transistors or oxide thin film transistors.

According to example embodiments, the display apparatus further includes a scan driver configured to supply the scan signals to each of the plurality of scan lines; a data driver configured to supply the data signals to each of the plurality of data lines; and a power supply unit configured to supply the first common power and the second common power to the first and second common power lines, respectively.

According to example embodiments, the display element is an electrochromic element, a liquid crystal element, or an electronic ink element.

According to example embodiments, the pixel electrode, the first transistor, the second transistor, the capacitor, the plurality of scan lines, the plurality of data lines and the second common power line of the display element are on a first substrate, the opposite electrode and the first common power line of the display element are on a second substrate facing the first substrate, and the plurality of scan lines and the second common power line are on the first substrate in a same layer.

According to example embodiments, a method of driving a display apparatus including a plurality of pixels at intersections of a plurality of scan lines and a plurality of data lines, each of the plurality of pixels including a display element including a pixel electrode and an opposite electrode; a first transistor including a first electrode electrically connected to one of the plurality of data lines, a second electrode electrically connected to a first node, and a gate electrically connected to one of the plurality of scan lines; a capacitor including a first electrode electrically connected to the first node and a second electrode; and a second transistor including a first electrode electrically connected to the pixel electrode, a second electrode, and a gate electrically connected to the first node, the method including an addressing operation of delivering a plurality of data signals and a plurality of scan signals to the plurality of pixels and writing image information on all of the plurality of pixels; and a displaying operation of applying common power to all of the plurality of pixels and displaying an image according to the image information on each of the plurality of pixels.

According to example embodiments, the addressing operation includes sequentially delivering the plurality of scan signals to the plurality of scan lines; delivering the plurality of data signals to the plurality of data lines; delivering the plurality of data signals to the first node according to the delivered scan lines; and storing the plurality of data signals in the capacitor.

According to example embodiments, the displaying operation includes commonly applying a first common power to the opposite electrode of the display element; commonly applying a second common power to the second electrode of the second transistor; and applying the second common power to the pixel electrode of the display element according to the data signals stored in the capacitor.

According to example embodiments, a potential difference between the first common power and the second common power is inverted before a succeeding frame of an image is displayed.

According to example embodiments, the first common power and the second common power are simultaneously applied to all of the plurality of pixels.

According to example embodiments, a potential difference between the first common power and the second common power is inverted before a succeeding frame of an image is displayed.

According to example embodiments, a gradation is expressed by dividing a frame into a plurality of sub-frames, and performing the addressing operation and the displaying operation with respect to each of the plurality of sub-frames.

### BRIEF DESCRIPTION OF THE DRAWINGS

The above and other features and advantages will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a circuit diagram of a pixel circuit according to example embodiments;

FIG. 2 is a diagram of pixel arrays of the pixel circuit of FIG. 1;

FIG. 3 is a diagram of a display apparatus including the pixel circuit of FIG. 1;

FIG. 4 is a timing diagram for explaining a method of driving the display apparatus of FIG. 3 according to example embodiments;

FIG. 5 is a schematic cross-sectional view of a display apparatus according to example embodiments; and

FIG. 6 is a diagram of a layout of a pixel circuit of the display apparatus of FIG. 5.

### DETAILED DESCRIPTION

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

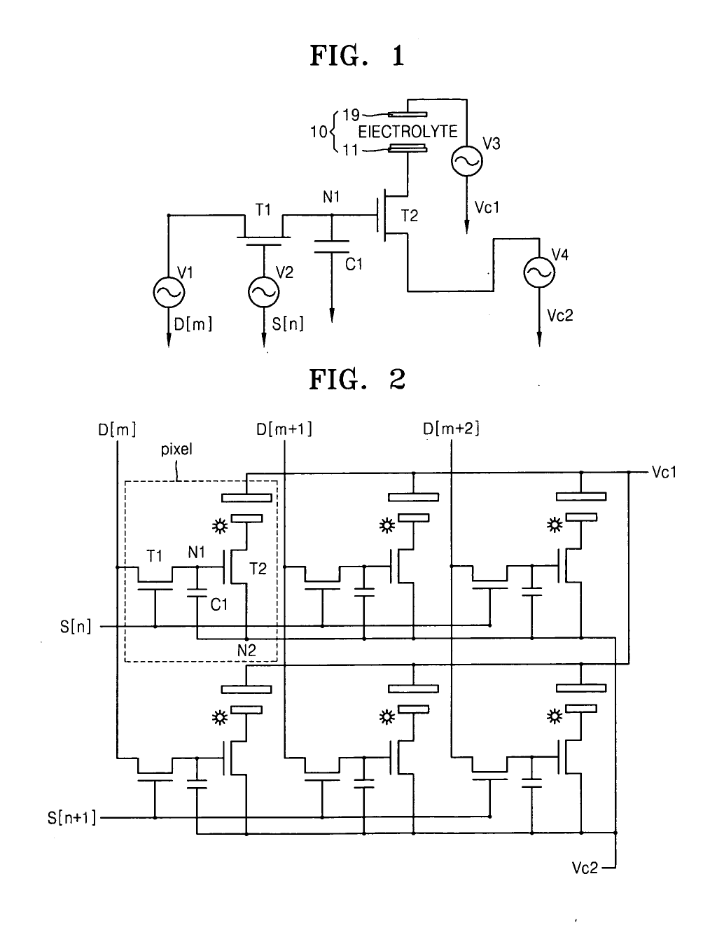

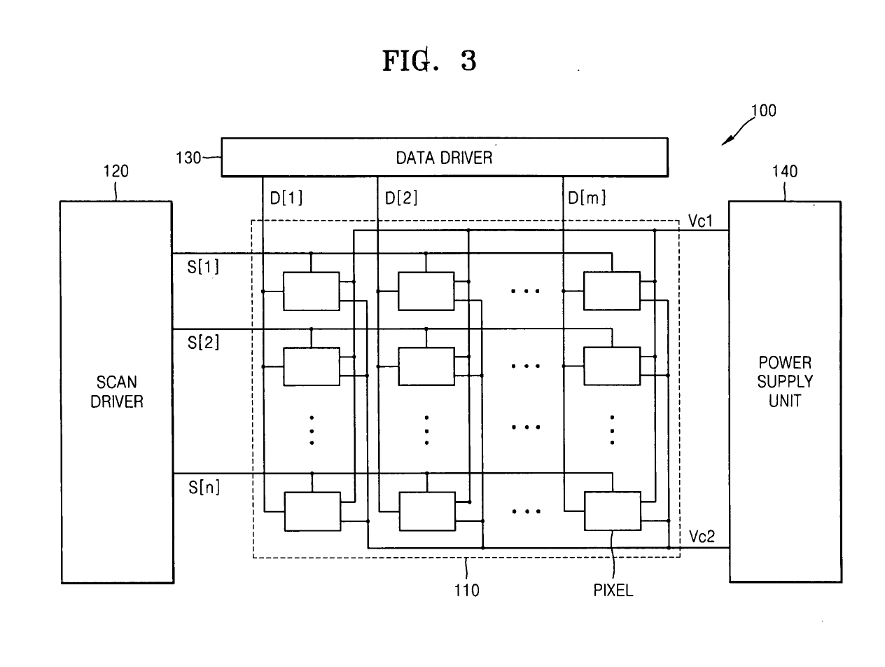

FIG. 1 is a circuit diagram of a pixel circuit according to example embodiments. FIG. 2 is a diagram of pixel arrays of the pixel circuit of FIG. 1 according to example embodiments. FIG. 3 is a diagram of a display apparatus 100 including the pixel circuit of FIG. 1.

Referring to FIG. 1, the pixel circuit of example embodiments relates to each of pixels of the display apparatus 100 of FIG. 3, which may be an active matrix display, and includes a display element 10, two transistors T1 and T2, and a capacitor C1.

The display element 10 includes a pixel electrode 11, an opposite electrode 19, and a display material disposed between the pixel electrode 11 and the opposite electrode 19. The display material may include, for example, liquid crystals, electrophoretic electronic ink, and/or an electrochromic material, or the like, and may display a pixel by using a voltage and/or current applied between the pixel electrode 11 and the opposite electrode 19. The opposite electrode 19 is connected to a first common power line Vc1 commonly with respect to a plurality of pixels.

A first electrode of the first transistor T1 is connected to a data line D[m] of a plurality of data lines that deliver an addressing voltage of a column line (or a row line), i.e. a data signal V1. A second electrode of the first transistor T1 is electrically connected to a first node N1. A gate of the first transistor T1 is connected to a scan line S[n] of a plurality of scan lines that deliver an addressing voltage of a row line (or a column line), i.e. a scan signal V2. The first and second electrodes of the first transistor T1 may respectively be source and drain electrodes. The first transistor T1, which is a switching transistor, delivers the data signal V1 to the first node N1 in response to the scan signal V2.

The capacitor C1 maintains the data signal V1 delivered through the first transistor T1 during a predetermined desired period of time. A first electrode of the capacitor C1 is electrically connected to the first node N1. A second electrode of the capacitor C1 is commonly and electrically connected to a second common power line Vc2 or is grounded. Referring to FIG. 2, the second electrode of the capacitor C1 is connected to the second common power line Vc2 through a second node N2. Referring back to FIG. 1, the capacitor C1 is charged with an amount of charge corresponding to an operating voltage of the second transistor T2 when the first transistor T1 is powered on, and maintains the operating voltage when a corresponding frame of an image is displayed.

A first electrode of the second transistor T2 is electrically connected to the pixel electrode 11. A second electrode of the second transistor T2 is connected to the second common power line Vc2. A gate of the second transistor T2 is electrically connected to the first node N1. The second transistor T2, which is a driving transistor, applies a second common power V4 to the pixel electrode 11 in response to a signal applied to the first node N1. The first and second electrodes of the second transistor T2 may respectively be source and drain electrodes.

The first and second transistors T1 and T2 of example embodiments may be, for example, amorphous silicon thin film transistors (a-Si TFTs), poly-silicon thin film transistors (poly-Si TFTs), oxide thin film transistors, and/or organic thin film transistors, or the like. When an electrochromic element having a relatively small resistance is employed in the display element 10, a pixel circuit requires a transistor having a high mobility, such as a poly-silicon thin film transistor. However, since the display apparatus 100 of example embodiments, which will be described later, displays a whole (complete) image during a response time of a pixel, even if a transistor having a low mobility, such as an amorphous silicon thin film transistor, is used in the pixel circuit, the transistor can deliver a sufficient amount of charge to the display element 10 while not greatly increasing a time taken to display a whole image. Thus, the example embodiments are not limited to any particular type of transistors in the pixel circuit. Therefore, the pixel circuit according to example embodiments can use an amorphous silicon thin film transistor or an oxide TFT, as for design and/or manufacturing costs.

Referring to FIGS. 2 and 3, the display apparatus 100 includes a pixel array 110, a scan driver 120 for supplying the scan signal V2 to the pixel array 110, a data driver 130 for supplying the data signal V1 to the pixel array 110, and a power supply unit 140 for supplying power to the pixel array 110.

A plurality of pixels each including the pixel circuit of example embodiments is arranged in the pixel array 110 in a 2D manner. Each pixel of the pixel array 110 is disposed in positions where the plurality of scan lines S[1], S[2], . . . , S[n] and the plurality of data lines D[1], D[2], . . . , D[m] cross each other. Column and row lines shown in FIGS. 2 and 3 may be switched.

The scan driver 120 supplies the scan signal V2 to the gate of the first transistor T1 of each pixel through a plurality of scan lines S[1], S[2], . . . , S[n], each scan line corresponding to pixels in each column of the pixel array 110.

The data driver 130 supplies the data signal V1 to the first electrode of the first transistor T1 of each pixel through a plurality of data lines D[1], D[2], . . . , D[m], each data line corresponding to pixels in each row of the pixel array 110.

The scan lines S[1], S[2], . . . , S[n] may correspond to column electrodes. The data lines D[1], D[2], . . . , D[m] may correspond to row electrodes. When occasion demands, the column electrodes and the row electrodes may be switched with each other.

The power supply unit 140 commonly supplies power with respect to all pixels of the pixel array 110. The first common power line Vc1 is commonly connected to the opposite electrode 19 of the display element 10 of each pixel and supplies a first common power V3. The second common power line Vc2 is commonly connected to the second electrode of the second transistor T2 of each pixel and supplies the second common power V4. The first common power V3 and the second common power V4 may be currents or voltages.

Next, a method of driving the display apparatus including the pixel circuit of example embodiments will be described with reference to FIGS. 1 through 3.

The method of driving the display apparatus including the pixel circuit includes addressing and/or displaying operations.

An initial status of the display apparatus may have a color according to a display element. For example, the initial status of the display apparatus may have a black screen or a white screen.

In the addressing operation, image information is sequentially written in a plurality of pixel circuits. To this end, the scan driver 120 sequentially selects the scan lines S[1], S[2], . . . , S[n] and delivers the scan signals V2 to the selected scan lines S[1], S[2], . . . , S[n]. The data driver 130 delivers the data signals V1 to the data lines D[1], D[2], . . . , D[m]. In this regard, the data driver 130 sequentially delivers the data signals V1 to the data lines D[1], D[2], . . . , D[m] with respect to the scan lines S[1], S[2], . . . , S[n] sequentially selected by the scan driver 120.

The data signal V1 may be a voltage signal having an operating voltage for turning the second transistor T2 of each pixel ON or OFF, for example, between about 0 V and about 10 V. The scan signal V2 may be a voltage signal having, for example, a voltage between about −5 V and 15 V to perform a gate addressing operation on the first transistor T1 of each pixel. The first transistor T1 is turned ON or OFF according to the delivered scan signal V2. When the scan signal V2 for turning the first transistor T1 ON is applied, the data signal V1 input through the first electrode of the first transistor T1 is delivered to the first node N1, and the capacitor C1 (of each pixel) is charged with charges according to a potential difference between the data signal V1 applied to the first electrode thereof and the second electrode thereof. The second electrode of the capacitor C1 is, for example, connected to the second common power line Vc2 or is grounded. Even when the scan signal V2 is applied to a following scan line from among the scan lines S[1], S[2], . . . , S[n] and no data signal V1 is delivered to the first node N1 of a corresponding pixel, the capacitor C1 may maintain a potential difference sufficient to turn the second transistor T2 ON to the first node N1 according to the stored/accumulated/supplied charges. When the second signal V2 for turning the first transistor T1 OFF is applied, the second transistor T2 is turned OFF. Since the data signal V1 input through the first electrode of the first transistor T1 is not delivered to the first node N1, the capacitor C1 is not charged. Charges stored in the capacitor C1 correspond to the data signal V1 and thus the capacitor C1 may store the data signal V1.

Such an addressing operation is performed until the scan signal V2 is applied to all the scan lines S[1], S[2], . . . , S[n] with respect to all 2D matrix pixels constituting a screen. That is, a charging operation corresponding to image information with respect to all pixels is performed by the capacitor C1.

The displaying operation is to display an image by commonly applying power to all pixels after the addressing operation is performed. The displaying operation may be performed by commonly applying the first common power V3 to the opposite electrode 19 of the display element 10 of each pixel and commonly applying the second common power V4 to the second electrode of the second transistor T2 of each pixel. If the display element 10 is an electrochromic element, the first common power V3 may be ±3V, and the second common power V4 may also be ±3V. If the second common power V4 is applied to the second electrode of the second transistor T2, the second common power V4 is delivered to the pixel electrode 11 of the display element 10 (of each pixel) according to the driving signal V1 stored in the capacitor C1. In this operation, reflectance of the display element 10 changes.

As described above, since the first common power Vc1 and the second common power Vc2 are applied through the power supply unit 140, a potential difference between the first common power Vc1 and the second common power Vc2 is easily and appropriately adjusted to correspond to the electric characteristics of the display element 10. Thus, the pixel circuit of example embodiments may be independently driven, relatively, with respect to the electric characteristics of the display element 10.

Meanwhile, if a frame of an image is displayed, the potential difference between the first common power Vc1 and the second common power Vc2 is inverted, and power is supplied during an operation of displaying a next frame. If +3V and −3V are respectively applied to the first common power Vc1 and the second common power Vc2 on a first frame, −3V and +3V are respectively applied to the first common power Vc1 and the second common power Vc2 on a second frame. As described above, the display elements 10 may be simultaneously refreshed and display a new frame by using a frame inversion method of inversing a polarity of a frame.

The displaying operation closely related to a response speed of the display element 10 is separate/distinct from the addressing operation for each frame of the image, thereby naturally displaying the whole image and quickly updating the frame of the image even if the display element 10 has a slow response speed.

When a frame of an image is displayed by using a line-by-line addressing method, a time taken to display the frame of the image is proportional to the number of rows. However, an electrochromic element has a relatively slow response time of 200 ms per pixel. If the resolution of a display apparatus using an electrochromic element is a quarter video graphics array (QVGA), since the number of rows is 240, time taken to display the frame of the image using the line-by-line addressing method is 200 ms*240.48 seconds. This, for example, is a time taken to display a frame of an image for a display apparatus including a display element having a slow response speed and using the line-by-line addressing method. Furthermore, a time taken to display the frame of the image increases according to an increase in the resolution of the display apparatus.

Meanwhile, the displaying operation is separated from the addressing operation as described above and thus the frame of the image is displayed within a response time of a single pixel, thereby realizing the display apparatus (as a functional/quick display apparatus even when) using the display element having a slow response speed. Further, a time taken to perform the addressing operation is relatively shorter than the response time of the display element and may be disregarded, and thus the time taken to display the frame may not substantially increase even when the resolution of the display apparatus is increased.

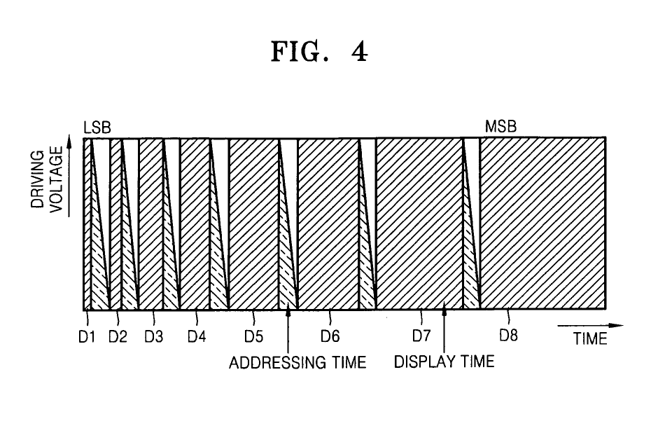

FIG. 4 is a timing diagram for explaining a method of driving a display apparatus according to example embodiments. Referring to FIG. 4, the method of driving the display apparatus expresses a gradation by dividing a frame of an image into a plurality of sub-frames. For example, a frame is divided into 8 sub-frames D1, D2, . . . D8, and addressing and displaying operations are repeatedly performed with respect to each sub-frame, so that the sub-frames D1, D2, . . . D8 are displayed one by one every displaying operation, and overlap to form a frame. In this regard, time taken to maintain the displaying operation on each sub-frame may be different by a power of 2. Thus, when a frame is divided into the 8 sub-frames D1, D2, . . . D8 with reference to FIG. 8, the method of driving the display apparatus expresses the gradation of 2⁸=256.

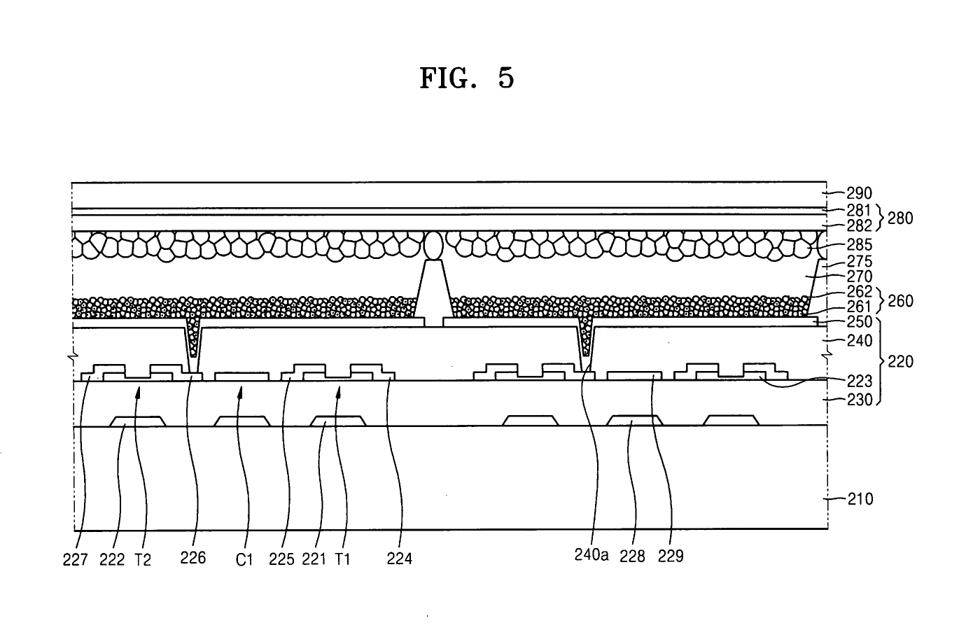

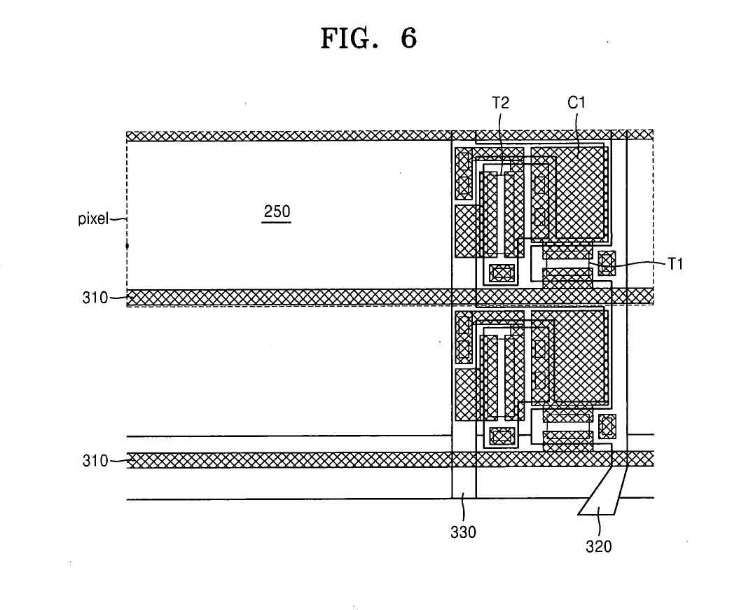

FIG. 5 is a cross-sectional view of a display apparatus according to example embodiments. FIG. 6 is a diagram of a layout of a pixel circuit of the display apparatus of FIG. 5.

Referring to FIG. 5, the display apparatus t uses an electrochromic element as a display element and includes a first substrate 210, a second substrate 290 spaced apart from the first substrate 210, and an electrolyte 270 filled between the first substrate 210 and the second substrate 290.

The first substrate 210 may be a transparent substrate. For example, the first substrate 210 may be a glass transparent substrate or a flexible plastic substrate formed of any of polymer materials such as polyethylene terephthalate (PET), polyethylene naphathalate (PEN), polycarbonate (PC), polystyrene, polyacrylate, and/or polyether sulfone (PES), and the like. The second substrate 290 may be formed of the same material as or different materials from the first substrate 210. For example, the second substrate 290 may be formed of an opaque material. As occasions demand, the first substrate 210 may be formed of a transparent material, and the second substrate 290 may be formed of an opaque material. In this case, the display apparatus may not include a reflective layer 285.

A pixel circuit unit 220 is disposed on the first substrate 210 to form a back plane. The pixel circuit unit 220 includes first and second transistors T1 and T2 formed on the first substrate 210, a capacitor C1, and a pixel electrode 250.

Gate electrodes 221 and 222 of the first and second transistors T1 and T2 and a second electrode 228 of the capacitor C1 are stacked on the first substrate 210. Furthermore, referring to FIG. 6, a scan line 320 and a second common power line 330 and the gate electrodes 221 and 222 of the first and second transistors T1 and T2 and the second electrode 228 of the capacitor C1 are simultaneously stacked on the first substrate 210 in the same layer. The scan line 320 is electrically connected to the gate 221 of the first transistor T1. The second electrode 228 of the capacitor C1 is electrically connected to the second common power line 330.

An insulation layer 230 covers the gate electrodes 221 and 222 of the first and second transistors T1 and T2. A semiconductor layer 223, first electrodes 224 and 226 and second electrodes 225 and 227 of the first and second transistors T1 and T2 are disposed on the insulation layer 230. The semiconductor layer 223 may be formed of an amorphous silicon material. A first electrode 229 of the capacitor C1 and the first electrodes 224 and 226 and the second electrodes 225 and 227 of the first and second transistors T1 and T2 are disposed on the insulation layer 230. Furthermore, referring to FIG. 6, a data line 310, the first electrodes 224 and 226 and the second electrodes 225 and 227 of the first and second transistors T1 and T2, and the first electrode 229 of the capacitor C1 are disposed on the insulation layer 230. In this regard, the data line 310 is electrically connected to the first electrode 224 of the first transistor T1, and the second electrode 225 of the first transistor T1 and the first electrode 229 of the capacitor C1 are electrically connected to each other. Meanwhile, a via hole (not shown) is formed in the insulation layer 230 and then the first electrode 229 of the capacitor C1 is electrically connected to the gate 222 of the second transistor T2 disposed in a lower portion of the insulation layer 230. Another via hole (not shown) is formed in the insulation layer 230 and then the second electrode 227 of the second transistor T2 is electrically connected to the second common power line 330 disposed in the lower portion of the insulation layer 230. As described above, the second common power line 330 is commonly connected to the second electrode 227 of the second transistor T2 of all pixels.

A protective layer 240 covers the first electrodes 224 and 226 and the second electrodes 225 and 227 of the first and second transistors T1 and T2 and the first electrode 229 of the capacitor C1. The pixel electrode 250 is disposed on the protective layer 240.

A contact hole 240a is formed in the protective layer 240 to expose the first electrode 226 of the second transistor T2. The pixel electrode 250 is electrically connected to the first electrode 226 of the second transistor T2 through the contact hole 240a.

The pixel electrode 250 is formed for each of unit pixels on the protective layer 240. The pixel electrode 250 may be formed of a transparent conductive material, for example, indium tin oxide (ITO), tin oxide doped with fluorine (FTO), ZnO—Ga₂O₃, ZnO—Al₂O₃, SnO₂—Sb₂O₃, and/or a transparent conductive polymer material such as polythiophene.

An electrochromic layer 260 is formed on the pixel electrode 250. The electrochromic layer 260 may be, for example, an electrochromic semiconductor layer 261 on which an electrochromic material 262 is adsorbed. The electrochromic layer 260 may be formed of at least one selected from the group consisting of a titanium-based oxide, a zirconium-based oxide, a strontium-based oxide, a niobium-based oxide, a hafnium-based oxide, an indium-based oxide, a tin-based oxide, and a zinc-based oxide. The electrochromic material 262 is adsorbed on an upper surface of the electrochromic semiconductor layer 261. The electrochromic material 262, for example, an n-type electrochromic material, is adsorbed on the upper surface of the electrochromic semiconductor layer 261, receives moving electrons from the electrochromic semiconductor layer 261 resulting in a change in its molecular structure, thereby producing a chromic effect. However, example embodiments including an electrochromic material using an electrochromic element field are not limited thereto. For example, the electrochromic material 262 may be a viologen compound.

An opposite electrode 280 formed of a conductive material is formed on a lower surface of the second substrate 290, i.e., a surface opposite to the first substrate 210. The reflective layer 285 is formed on the lower surface of the opposite electrode 280. The opposite electrode 280 is disposed to face the pixel electrode 250. The opposite electrode 280 is connected to the first common power line Vc1 (of FIG. 3). All types of opposite electrodes formed of a conductive material may be used as the opposite electrode 280. The opposite electrode 280 may be formed of an additional conductive material in order to increase a work function (thereof). For example, the opposite electrode 280 may include a double layer of an indium tin oxide (ITO) electrode layer 281 formed on the second substrate 290 and an antimony doped tin oxide (ATO) electrode layer 282 formed on the ITO electrode layer 281. The opposite electrode 280 may include the insulation material if a conductive material is included in a side of the opposite electrode 280 facing a transparent electrode. The opposite electrode 280 may be formed of an electrochemically stable material, for example, platinum, gold, and/or carbon.

Further, an oxidation-deoxidation material, or a p-type electrochromic material may be adsorbed on the opposite electrode 280. The oxidation-deoxidation material, or the p-type electrochromic material is oxidized and maintains an electrical neutral state, when the n-type electrochromic material 262 is deoxidized on the electrochromic layer 260. The p-type electrochromic material may be contained in the electrolyte 270 or may be adsorbed in the electrolyte 270 and the opposite electrode 280. For example, Prussian blue, ferrocene compound derivatives, and phenothiazine compound derivatives may be used as the p-type electrochromic material and the oxidation-deoxidation material used in the opposite electrode 280.

The reflective layer 285 may be formed on the ATO electrode layer 282. The reflective layer 285 may contain, for example, platinum. At least one selected from the group consisting of titanium-based oxide, zirconium-based oxide, strontium-based oxide, niobium-based oxide, hafnium-based oxide, indium-based oxide, tin-based oxide, and zinc-based oxide may be used as the reflective layer 285. However, example embodiments are not limited thereto, and the reflective layer 285 may be formed of one or a mixture of two or more thereof. The size of metal oxide particles of the reflective layer 285 may be, for example, between about 100 and 500 nm. For example, the reflective layer 285 may use a metal oxide formed of the same material as the electrochromic layer 260 and having metal oxide particles greater in size than the electrochromic layer 260.

A barrier wall 275 used to define a space for containing the electrolyte 270 in a location corresponding to the electrochromic layer 260 is formed on the protective layer 240 and the pixel electrode 250.

The display apparatus is driven by writing image information on the capacitor C1 according to data signals and scan signals with respect to all pixels during an addressing operation and applying first and second common power during a displaying operation. For example, the first common power line may be ±3V, and the second common power may also be ±3V. If the first and second common power is applied, a potential difference is generated-across ends of the pixel electrode 250 and the opposite electrode 290 according to whether the second transistor T2 is turned ON or OFF. The electrochromic material 262 moves into the electrochromic semiconductor layer 261 according to the potential difference and performs an oxidation or deoxidation response and thus a color thereof visibly changes or a shade of color changes, thereby displaying a pixel. As described above, a display apparatus using an electrochromic element has a relatively slow electrochromic response time of 200 ms. However, since the display apparatus separately performs the addressing operation and the displaying operation with respect to the frame of the image, although the electrochromic element has a slow response speed, the display apparatus of example embodiments may display an image relatively quick and quickly update the frame of the image.

The display apparatus according to example embodiments uses an electrochromic element; however, example embodiments are not limited thereto. The pixel circuit may be used in a display apparatus employing various types of display elements, for example, liquid crystal display devices using a liquid crystal element and/or e-ink display devices using electrophoretic electronic ink.

As described above, according to example embodiments, the pixel circuit, the display apparatus including the pixel circuit, and the method of driving the display apparatus have the following effects.

First, the frame of the image is simultaneously displayed, thereby displaying the image relatively quick and quickly updating the frame of the image in a display apparatus using a display element having a slow response speed.

Second, power consumption and/or complexity of a circuit caused by driving the display element having a slow response speed is/are reduced.

Third, the electrical characteristics of the display element are relatively independent.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A pixel circuit comprising:
a display element including a pixel electrode and an opposite electrode to which a first common power is applied;
a first transistor including a first electrode to which a data signal is applied, a second electrode electrically connected to a first node, and a gate to which a scan signal is including;
a capacitor including a first electrode electrically connected to the first node and a second electrode; and
a second transistor including a first electrode electrically connected to the pixel electrode, a second electrode to which a second common power is applied, and a gate electrically connected to the first node.

2. The pixel circuit of claim 1, wherein the second electrode of the capacitor is electrically connected to a line to which the second common power is applied or is grounded.

3. The pixel circuit of claim 1, wherein the first and second transistors are amorphous silicone thin film transistors or oxide thin film transistors.

4. The pixel circuit of claim 1, wherein the display element is an electrochromic element, a liquid crystal element, or an electronic ink element.

5. A display apparatus comprising:
a plurality of scan lines to which a plurality of scan signals are applied;
a plurality of data lines intersecting the plurality of scan lines and to which a plurality of data signals are applied;
a first common power line to which a first common power is supplied;
a second common power line to which a second common power is supplied; and
a plurality of pixels at locations where the plurality of scan lines and the plurality of data lines intersect each other,
wherein each of the plurality of pixels includes:
a display element including a pixel electrode and an opposite electrode electrically connected to the first common power line;
a first transistor including a first electrode electrically connected to one of the plurality of data lines and to which a data signal is applied, a second electrode electrically connected to a first node, and a gate electrically connected to one of the plurality of scan lines and to which a scan signal is applied;
a capacitor including a first electrode electrically connected to the first node and a second electrode; and
a second transistor including a first electrode electrically connected to the pixel electrode, a second electrode electrically connected to the second common power line, and a gate electrically connected to the first node.

6. The display apparatus of claim 5, wherein the second electrode of the capacitor is electrically connected to the second common power line or is grounded.

7. The display apparatus of claim 5, wherein the first and second transistors are amorphous silicone thin film transistors or oxide thin film transistors.

8. The display apparatus of claim 5, further comprising:
a scan driver configured to supply the scan signals to each of the plurality of scan lines;
a data driver configured to supply the data signals to each of the plurality of data lines; and
a power supply unit configured to supply the first common power and the second common power to the first and second common power lines, respectively.

9. The display apparatus of claim 5, wherein the display element is an electrochromic element, a liquid crystal element, or an electronic ink element.

10. The display apparatus of claim 5, wherein the pixel electrode, the first transistor, the second transistor, the capacitor, the plurality of scan lines, the plurality of data lines and the second common power line of the display element are on a first substrate,
the opposite electrode and the first common power line of the display element are on a second substrate facing the first substrate, and
the plurality of scan lines and the second common power line are on the first substrate in a same layer.

11. A method of driving a display apparatus including a plurality of pixels at intersections of a plurality of scan lines and a plurality of data lines, each of the plurality of pixels including a display element including a pixel electrode and an opposite electrode; a first transistor including a first electrode electrically connected to one of the plurality of data lines, a second electrode electrically connected to a first node, and a gate electrically connected to one of the plurality of scan lines; a capacitor including a first electrode electrically connected to the first node and a second electrode; and a second transistor including a first electrode electrically connected to the pixel electrode, a second electrode, and a gate electrically connected to the first node, the method comprising:
an addressing operation of delivering a plurality of data signals and a plurality of scan signals to the plurality of pixels and writing image information on all of the plurality of pixels; and
a displaying operation of applying common power to all of the plurality of pixels and displaying an image according to the image information on each of the plurality of pixels.

12. The method of claim 11, wherein the addressing operation comprises:
sequentially delivering the plurality of scan signals to the plurality of scan lines;
delivering the plurality of data signals to the plurality of data lines;
delivering the plurality of data signals to the first node according to the delivered scan lines; and
storing the plurality of data signals in the capacitor.

13. The method of claim 12, wherein the displaying operation comprises:
commonly applying a first common power to the opposite electrode of the display element;
commonly applying a second common power to the second electrode of the second transistor; and
applying the second common power to the pixel electrode of the display element according to the data signals stored in the capacitor.

14. The method of claim 13, wherein a potential difference between the first common power and the second common power is inverted before a succeeding frame of an image is displayed.

15. The method of claim 13, wherein the first common power and the second common power are simultaneously applied to all of the plurality of pixels.

16. The method of claim 15, wherein a potential difference between the first common power and the second common power is inverted before a succeeding frame of an image is displayed.

17. The method of claim 11, wherein a gradation is expressed by dividing a frame into a plurality of sub-frames, and performing the addressing operation and the displaying operation with respect to each of the plurality of sub-frames.
